(19) United States
(12) Patent Application Publication
(10) Pub. No.: US 2005/0254799 A1
(43) Pub. Date: Nov. 17, 2005

(54) Brushless dc fan motor

(75) Inventors: Masato Murara, Nagano (JP); Naruhiko Kudou, Nagano (JP); Munenori Takakuwa, Nagano (JP)

Correspondence Address: RANKIN, HILL, PORTER & CLARK LLP, 4080 ERIE STREET, WILLOUGHBY, OH, 44094-7836, US

(73) Assignee: Sanyo Denki Co., Ltd., Tokyo (JP)

(21) Appl. No.: 10/509,859

(22) PCT Filed: Sep. 30, 2003
(86) PCT No.: PCT/JP03/12531

§ 371 Date: Nov. 8, 2004

(30) Foreign Application Priority Data
Sep. 30, 2002 (JP) 2002-285003

(51) Int. Cl. H02P 7/08

(52) U.S. Cl. 388/809

(57) ABSTRACT

A brushless DC fan motor capable of communicating with an external apparatus while simplifying the circuitry. A speed control command generator, which generates a command for controlling the rotational speed of the rotor, include a microcomputer (9a) capable of bi-directional communication with an external apparatus (1) by serial communication based on a predetermined communication protocol. The microcomputer (9a) operates the speed control command based on control conditions transmitted from the external apparatus (1) and a signal indicative of the rotational speed and/or the exciting current detected by a speed detector (13) and/or a current detector (15) incorporated in the brushless DC fan motor (1). A drive circuit (7) controls the exciting current by PWM control according to an optimal speed control command.

### FIELD OF THE INVENTION

The present invention relates to a brushless direct current fan motor.

### BACKGROUND OF THE INVENTION

The brushless direct current fan motor comprises a rotor having a plurality of blades, a stator having excitation windings to be excited to rotate the rotor, a drive circuit, arranged at the stator side, for supplying excitation current to the excitation windings according to a speed control command, and a speed control command generating means, arranged at the stator side, for executing operation according to an inputted signal and generating the speed control command. The excitation current is switched corresponding to the location of the rotor detected by a location detector including a hole effect element. In many cases, all of the input signals to be inputted to the speed control command generating means are internally generated in the fan motor. In some cases, however, the inputted signals are input from an external circuit or external equipment.

A conventional brushless direct current fan motor, however, processes a command from an external equipment by using an analog circuit. Then the conventional brushless fan motor has had a problem that a circuitry configuration in the brushless direct current fan motor was complicated, because an additional circuit was needed to convert a digital command from the external equipment into an analog voltage signal for processing.

Accordingly an object of the present invention is to provide a brushless direct current fan motor which can communicate with an external equipment and which simplifies the circuit configuration.

Another object of the present invention is to provide a brushless direct current fan motor which can easily improve a airflow-static pressure characteristic.

Yet another object of the present invention is to provide a brushless direct current fan motor which can reduce the noise when rotating at low speed without changing a configuration of a drive circuit to be used.

### DISCLOSURE OF THE INVENTION

The present invention aims at improvements of a brushless direct current fan motor comprising a rotor having a plurality of blades, a stator having excitation windings to be excited to rotate the rotor, a drive circuit, arranged at the stator side, for supplying excitation current to the excitation windings according to a speed control command, and a speed control command generating means, arranged at the stator side, for executing operation according to an input signal and generating the speed control command.

According to the present invention, a speed control command generating means includes a microcomputer with a function which enables the microcomputer to communicate with an external equipment. With this arrangement, using the communication function of the microcomputer to receive a command, or input signal from the external equipment can be simplified. Moreover, the speed command operation can be simplified by using a microcomputer and, various types of controls can be carried out by modifying a program.

More specifically, a brushless direct current fan motor further comprises a speed detector for detecting a rotational speed of a rotor, and a current detector for detecting the excitation current supplied to the excitation windings. The drive circuit is so constructed as to supply the excitation current to the excitation windings under the pulse width modulation control. In this case, the microcomputer can be so programmed to carry out a function to operate the speed control command, with based on control conditions transmitted from the external equipment and on a signal indicating the rotation speed detected by the speed detector and/or a signal indicating the excitation current detected by the current detector. With this arrangement, the speed can be arbitrarily controlled by setting or modifying the program.

The microcomputer has a function which enables the microcomputer to bi-directionally communicate with the external equipment by serial communication based on the predetermined communication protocol. By predetermining the protocol between the microcomputer and the external equipment, a common program can be used even though the type of an external equipment is changed. Also by serial communication, the number of wirings for wire communication can be reduced.

Furthermore, the mounted microcomputer makes it easier to operate the speed control command for improving the airflow-static pressure characteristic, resulting in obtaining arbitrary airflow-static pressure characteristic.

In order to reduce power consumption as well as the noise produced when the motor rotates at low speed, the speed control command generating means is so constructed as to set the pulse width modulation control frequency of the drive circuit higher when the rotator rotates at low speed than at high speed. Because a vibratory sound of the motor is less loud during rotating at low speed, the pulse width modulation control frequency may be set to 16 KHz or more so that switching sounds get out of the audio frequency range in order to result in decreasing the noise of the fan motor. With this arrangement, the noise produced can be reduced, and an input current value is decreased, resulting in decreasing the power consumption consumed by switching elements. While rotating at high speed, the fan motor produces a louder hissing sound, which is heard when the fan rotates in the air. Since the switching sounds from the switching elements do not become hash, even though the pulse width modulation control frequency is set down to within the audio frequency range, the pulse width modulation control frequency at high speed rotation of the motor may be set to around 1 KHz. A switching loss by the switching elements can be suppressed low by lowering the frequency, though the input current increases, resulting in the reduced power consumption. Therefore, the power consumption at both low and high speed rotations of the motor, as well as the noise at low speed, can be decreased. More specifically, the speed control command generating means may be so constructed that the pulse width modulation control frequency is switched to 16 KHz when the motor rotates at low speed and to 1 KHz when the motor rotates at high speed.

### BRIEF DESCRIPTION OF THE DRAWINGS

FIG. 1 is a block diagram illustrating an example of a construction of a brushless direct current fan motor according to an embodiment of the present invention.

FIG. 2 shows a load characteristic (relationship between static pressure-airflow volume).

FIG. 3 shows a tendency of the characteristic of the brushless direct current fan motor.

FIG. 4 shows a tendency of the characteristic of the brushless direct current fan motor.

### BEST MODE FOR IMPLEMENTING THE INVENTION

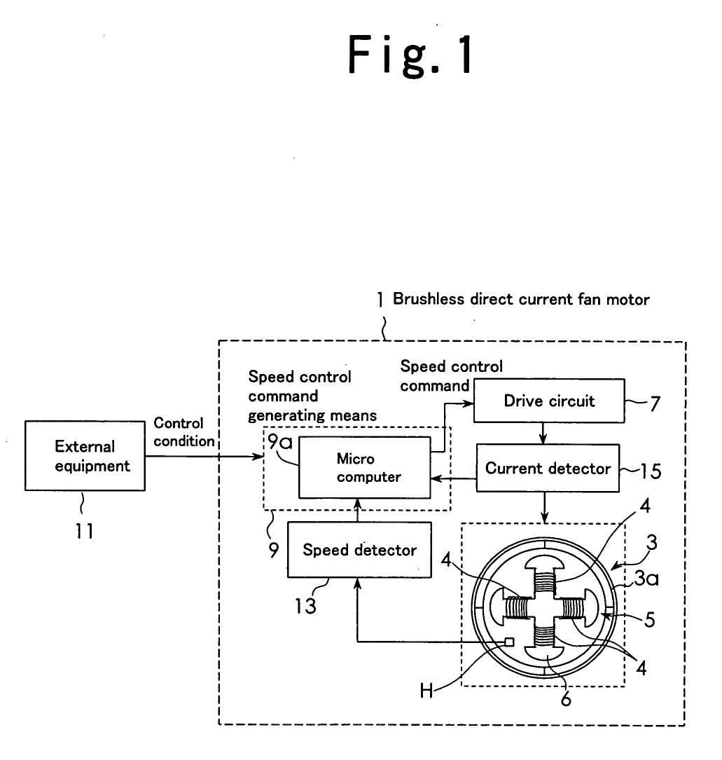

An embodiment of the present invention will be described in detail with reference to the accompanying drawings. FIG. 1 is a block diagram illustrating an example of a construction of a brushless direct current fan motor according to an embodiment of the present invention. In FIG. 1, a brushless direct current fan motor 1 comprises a rotor 3 having a plurality of blades, not shown, mounted at an outer peripheral portion of a magnetic rotor 3a, and a stator 5 in which a plurality of excitation windings 4 to be excited to rotate the rotor 3 are wound around a core 6. A hole effect element H is provided at the stator 5 side in order to detect a location of the magnetic rotor.

A drive circuit 7 includes a plurality of switching elements for supplying excitation current to the excitation wirings 4, and a pulse width modulation control signal generating means for PWM controlling the plurality of switching elements. A circuit substrate with the drive circuit 7 mounted thereon is fixed to the core 6 of the stator 5. Furthermore, a speed control command generating means 9, a speed detector 13 and a current detector 15 are each mounted on the circuit substrate.

The speed control command generating means 9 executes operation according to an input signal including a rotational speed of the rotor, a current value of the excitation current and control conditions. Then, the speed control command generating means 9 outputs a speed control command to a pulse width modulation control signal generating circuit, which is included in the drive circuit 7. In this embodiment, the speed control command generating means 9 includes a microcomputer 9a with a function which enables the microcomputer to communicate with an external equipment 11.

The speed detector 13 detects the rotational speed of the rotor 3. The speed detector 13 detects the location, as well as the speed, of the rotor 3 based on an output from a location detector comprising the hole effect element H. The current detector 15 detects the excitation current to be supplied to the excitation windings 4.

The microcomputer 9a included in the speed control command generating means 9 has a function which enables the microcomputer to communicate bi-directionally by serial communication with the external equipment 11 based on a predetermined communication protocol. The external equipment also has a built-in CPU, not shown, and the microcomputer 9a communicates with this CPU bi-directionally by using serial communication. Conditions and the rotational speed of the fan motor itself, as well as control conditions, to the external equipment 11 through this communication.

The microcomputer 9a operates the speed control command based on the control conditions transmitted from the external equipment 11 by such serial communication, and also based on a signal indicating the rotational speed detected by the speed detector 13 and/or the excitation current detected by the current detector 15. The drive circuit 7 supplies the excitation current to the excitation windings 4 under pulse width modulation control according to the speed control command thus operated. The brushless fan motor 1 of this embodiment of the present invention is speed-controlled by the microcomputer 9a according to the control conditions transmitted from the external equipment 11.

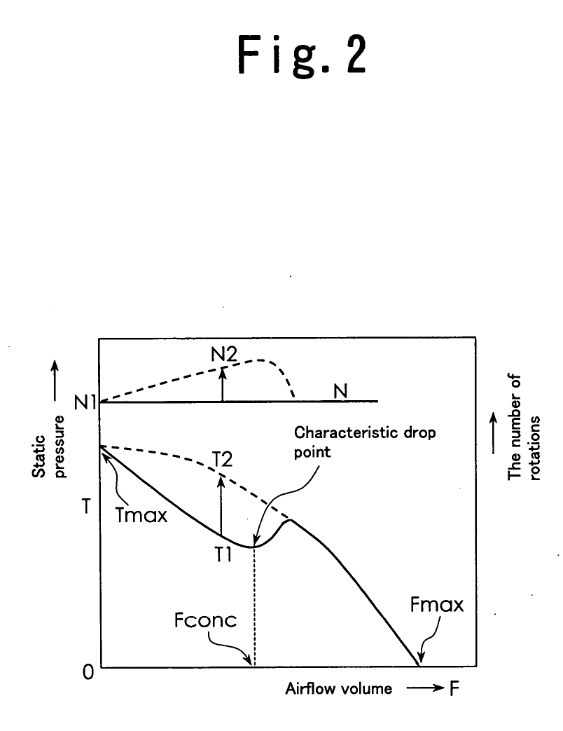

According to this embodiment, various types of controls can be carried out, because the microcomputer 9a is mounted in the blushless direct current fan motor. For example, the microcomputer 9a can be so programmed as to operate and output the speed control command for improving an airflow volume-static pressure characteristic, or an airflow volume F-static pressure or a torque T characteristic. A load characteristic, or the airflow volume characteristic to the static pressure, differs according to the conditions used for the external equipment 11. For example, FIG. 2 shows an example of the relationship between the static pressure and the airflow volume of the fan. In FIG. 2, a horizontal axis indicates the airflow volume F, a vertical axis on the left indicates the static pressure, or torque, T, and a vertical axis on the right indicates the number of rotations N. As shown by solid lines in FIG. 2, the static pressure T decreases as a function of the airflow volume F, when the number of rotations N is kept at a fixed value N1 and the airflow volume F is increased, or a block member which blocks an inlet or air intake side of the fan is gradually moved away. As the inlet side is blocked, namely when the airflow volume F=0, the static pressure T indicates the maximum value Tmax defined by the number of rotations N1. On the other hand, as resistance at the inlet side is decreased, or the block member is gradually moved away from the inlet side, the airflow volume F increases and the air easily flows, resulting in the reduced static pressure T. When the static pressure T is decreased to 0, the maximum value of airflow Fmax can be obtained. As shown in FIG. 2, the relation among the load characteristics is not indicated by a simple decrease function, but forms a small drop point at an airflow volume value Fconc smaller than the maximum airflow volume value Fmax. Three values of airflow volume exist for one torque value around such a drop point. Therefore the airflow is disturbed when the operational conditions of the fan varies among the three values for the airflow volume. If these characteristics are so adjusted beforehand with a program that the relationship between the static pressure and the airflow volume is a simple decrease function, this kind of problem can be solved. In other words, when the number of rotations is set to higher as shown by a dotted line, or set to N2, the static pressure indicates a simple decrease function of the airflow volume as shown by a dotted line. At this point, a change in the number of rotations N2 depicts a mountainous shape as shown by a dotted line. With this arrangement, one value of the airflow volume F corresponds to one static pressure T, and the unstable phenomena as described above can be avoided. Therefore a microcomputer 9a can be so programmed beforehand as to be able to adjust as described above.

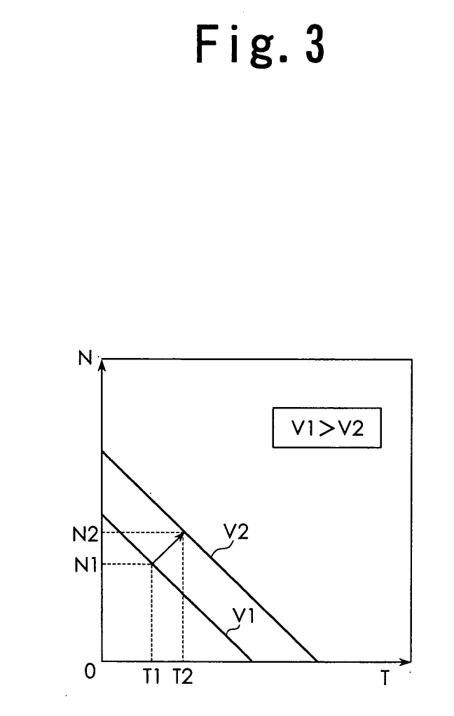

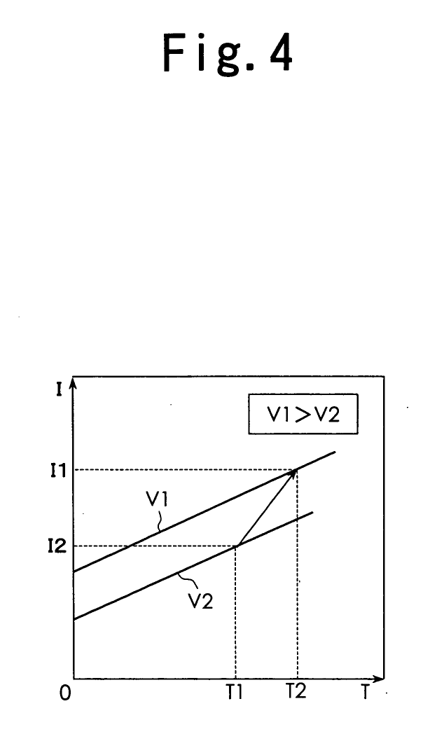

The above adjustment by the speed control command can be done by using, for example characteristics of brushless direct fan motor, relationship between the rotational speed and torque (N-T relationship) corresponding to the voltage applied to the excitation windings shown in FIG. 3, and relationship between the excitation current and torque (I-T relationship) corresponding to the voltage applied to the excitation windings as shown in FIG. 4. As shown in FIG. 3, in the brushless direct circuit fan motor, the rotational speed can be changed in relation to the torque by changing the voltage applied to the excitation windings (from V2 to V1). Furthermore as shown in FIG. 4, in the brushless direct circuit fan motor, the excitation current can be changed in relation to the torque, by changing the voltage applied to the excitation current (from V2 to V1). As described above, the torque can be adjusted by changing the values of the excitation current, the voltage applied to the excitation windings, and the rotational speed, which, in turn, can appropriately be used to adjust the characteristic of the airflow volume F to the torque T as shown in FIG. 2. More specifically, refer to the dotted line portion in FIG. 2, in order to improve the point to be fixed in the load characteristic which is unique to each type of the fans (the characteristic of the airflow volume to the static pressure), the data or pattern of changing the rotational speed, the voltage applied to the excitation windings, or the value of the excitation current for compensating the drop of the torque T are stored in a memory of the microcomputer 9a, and the current, voltage and speed are increased or decreased by adjusting the duty under the pulse width modulation control.

The memory in the microcomputer 9a built in the speed control command generating means 9 retains the data related to the volume of the airflow to the torque (FT related) as described above, and those data are transmitted to the microcomputer 9a through a communication line in real time after the airflow volume has been determined according to the operational conditions of the external equipment 11. The microcomputer 9a determines the values of the rotational speed N, voltage V, and current I of the brushless direct current fan motor 1 as described above, according to the transmitted airflow volume F.

If the fan motor is capable of communicating with the external equipment, the name of manufacturer of the fan motor, year, month, and date of manufacturing, a model number of the fan and a user-specified part number can be confirmed at the side of the external equipment 11. Thus the external equipment 11 can obtain the identified characteristics of the brushless direct current fan motor and give the control conditions to the microcomputer 9a, which is then enabled to execute complicated, flexible controls.

Furthermore, in the brushless direct current fan motor 1, the pulse width modulation control frequency of the drive circuit 7 is set higher when the rotor 3 rotates at low speed than at high speed by using the microcomputer 9a of the speed control command generating means 9. More specifically, the value of the pulse width modulation control frequency is set to 16 KHz or more so that the switching sounds get out of the audio frequency range, in order to suppress the noise produced while the fan is rotating at low speed. Since the value of input current is small, the power consumption of the switching elements can also be suppressed. When being set to the high speed rotation, the fan motor produces a louder hissing sound. Consequently, the switching sounds do not become harsh, even though the pulse width modulation control frequency is set down to within the audio frequency range. Therefore the pulse width modulation control frequency at high speed rotation of the motor is switched to around 1 KHz. when the input current increases, a loss of switching by the switching elements can be suppressed by lowering the frequency, resulting in the reduced power consumption.

In order to carry out the foregoing, an output from the speed detector 13 is compared with the predetermined reference speed. When the actual speed exceeds the reference speed, then it is determined that the fan is rotating at high speed, and when the actual speed is below the reference speed, it is determined that the fan is rotating at low speed. And the microcomputer is so programmed as to output a speed control command for switching the pulse width modulation frequency according to the determination.

According to this embodiment, the microcomputer built in the speed command generating means generates the speed control command which allows the load characteristic of the fan to be in the optimal condition. The CPU in the external equipment, under the predetermined communication protocol, gives the control conditions to the brushless direct current fan motor in real time. Then the brushless direct current fan motor can be flexibly controlled so as to operate in the optimal load condition.

Yet according to the embodiment, because the brushless direct current fan motor can bi-directionally transmit confirmation about the components including the fans for the external equipment and the control conditions for the external equipment, the external equipment can select the optimal control conditions when the brushless direct current fan motor uses such components.

Further according to the embodiment, when the pulse width modulation control frequency is set to the high-speed rotation, the low pulse width modulation frequency can be selected. Consequently, a small-type drive circuit with less electricity can be carried out.

### INDUSTRIAL APPLICABILITY

According to the present invention, the brushless direct current fan motor is advantageous, in that the fan motor can readily and simply be controlled by using the communication function of the microcomputers to receive a command or input signal from the external equipment, since the speed control command generating means comprises the microcomputer with a function which enables the microcomputer to communicate with the external equipment. Furthermore, using the microcomputer can simplify the speed command operation, and can also carry out various types of controls easily by modifying the programs.

1. A brushless direct current fan motor comprising:
a rotor having a plurality of blades;
a stator having excitation windings to be excited to rotate the rotor;
a drive circuit, arranged at the stator side, for supplying excitation current to the excitation windings according to a speed control command; and
a speed control command generating means, arranged at the stator side, for executing operation according to an input signal and generating the speed control command;
wherein the speed control command generating means includes a microcomputer that is operable to communicate with an external equipment.

2. The brushless direct current fan motor according to claim 1, further comprising:
a speed detector for detecting a rotational speed of the rotor; and
a current detector for detecting an excitation current flowing through the excitation windings;
wherein the drive circuit is constructed so as to supply the excitation current to the excitation current windings under pulse width modulation control;
wherein the microcomputer carries out a function to
operate the speed control command based on control conditions transmitted from the external equipment and a signal indicating the rotation speed detected by the speed detector and/or a signal indicating the excitation current detected by the current detector.

3. The brushless direct current fan motor according to claim 1, wherein the microcomputer has a function which enables the microcomputer to bi-directionally communicate with the external equipment by using serial communication based on a predetermined communication protocol.

4. The brushless direct current fan motor according to claim 1, wherein the microcomputer is programmed so as to operate and output the speed control command to improve characteristics of the airflow volume-static pressure characteristic.

5. The brushless direct current fan motor according to claim 1, wherein the speed control command generating means is constructed so that the pulse width modulation control frequency of the drive circuit is set higher when the rotator rotates at low speed than at high speed.

6. The brushless direct current fan motor according to claim 5, wherein the speed control command generating means is Constructed so that the pulse width modulation control frequency is switched to 16 KHz when a motor rotates at low speed and to 1 KHz when a motor rotates at high speed.

7. The brushless direct current fan motor according to claim 2, wherein the microcomputer has a function which enables the microcomputer to bi-directionally communicate with the external equipment by using serial communication based on a predetermined communication protocol.
